(19) United States
(12) Patent Application Publication
(10) Pub. No.: US 2011/0156673 A1
(43) Pub. Date: Jun. 30, 2011

(54) INTERNAL POWER GENERATING CIRCUIT AND SEMICONDUCTOR DEVICE INCLUDING THE SAME

(76) Inventor: Chul KIM, Gyeonggi-do (KR)

(21) Appl. No.: 12/716,836

(22) Filed: Mar. 3, 2010

(30) Foreign Application Priority Data
Dec. 30, 2009 (KR) 10-2009-0134550

(51) Int. Cl. G05F 1/10

(52) U.S. Cl. 323/280

(57) ABSTRACT

A semiconductor device includes an enable unit configured to enable an output terminal, a feedback unit configured to receive an output of the output terminal and output a feedback signal, an amplifying unit configured to amplify a difference between a reference signal and the feedback signal, and a transfer unit configured to transfer an amplified signal of the amplifying unit as an enable control signal of the enable unit, and to have an output resistance value smaller than an output resistance value of the amplifying unit.

### CROSS-REFERENCE TO RELATED APPLICATIONS

The present application claims priority of Korean Patent Application No. 10-2009-0134550, filed on Dec. 30, 2009, which is incorporated herein by reference in its entirety.

### BACKGROUND OF THE INVENTION

Exemplary embodiments of the present invention relate to an internal power generating circuit and a semiconductor device including the same for generating a power voltage.

Performance of semiconductor devices is being continuously improved. There are two main areas of improvements in semiconductor performance. One of them is to increase an operation speed of the semiconductor device. The other one is to reduce a power consumed in the semiconductor device.

In order to increase the operation speed of the semiconductor device, a frequency of a reference clock used in the semiconductor device is increased, or the performance of MOS transistors used in the semiconductor device is improved.

In order to reduce power consumed in the semiconductor device, the number of elements used in the semiconductor device is decreased, or a power saving mode is used such that supply of power to all circuit blocks except indispensable circuit blocks is terminated.

It is also possible to reduce power consumed in the semiconductor device by lowering a voltage level of an enable voltage used in the semiconductor device.

However, when the voltage level of the enable voltage used in the semiconductor device is lowered, noise may increase. Accordingly, it is desirable to develop an internal voltage generating circuit for supplying an internal voltage with minimum power consumption.

### SUMMARY OF THE INVENTION

In accordance with an embodiment of the present invention, a semiconductor device includes an enable unit configured to enable an output terminal, a feedback unit configured to receive an output of the output terminal and output a feedback signal, an amplifying unit configured to amplify a difference between a reference signal and the feedback signal, and a transfer unit configured to transfer an amplified signal of the amplifying unit as an enable control signal of the enable unit, and to have an output resistance value smaller than an output resistance value of the amplifying unit.

In accordance with another embodiment of the present invention, a semiconductor device includes an enable unit configured to receive an enable signal and to enable an output terminal, an feedback unit configured to receive an output signal of the output terminal and to output a feedback signal, an amplifying unit configured to receive a reference signal and the feedback signal and to output an amplified signal having a gain in proportion to an increase of the feedback signal, and a transfer unit configured to receive the amplified signal and to output the enable signal to the enable unit, wherein the transfer unit has an output resistance value smaller than an output resistance value of the amplifying unit.

In accordance with yet another embodiment of the present invention, an internal power generating circuit includes an enable unit configured to receive an enable signal and to enable an output terminal, an feedback unit configured to receive an output signal of the output terminal and to output a feedback signal, an amplifying unit configured to receive a reference signal and the feedback signal and to output an amplified signal having a gain in proportion to an increase of the feedback signal, and a transfer unit configured to receive the amplified signal and to output the enable signal to the enable unit, wherein the transfer unit has an output resistance value smaller than an output resistance value of the amplifying unit.

### BRIEF DESCRIPTION OF THE DRAWINGS

FIG. 1 is a block diagram illustrating an LDO circuit of an internal voltage generating circuit in accordance with a first embodiment of the present invention.

FIGS. 2A to 2D are circuit diagrams of a feedback unit shown in FIG. 1.

FIG. 3 is a circuit diagram illustrating an LDO circuit of an internal voltage generating circuit in accordance with a second embodiment of the present invention.

FIG. 4 is a block diagram illustrating an LDO circuit of an internal voltage generating circuit in accordance with a third embodiment of the present invention.

FIG. 5 is a circuit diagram illustrating an LDO circuit of an internal voltage generating circuit in accordance with a fourth embodiment of the present invention.

FIG. 6 is a circuit diagram illustrating an LDO circuit of an internal voltage generating circuit in accordance with a fifth embodiment of the present invention.

FIG. 7 is a circuit diagram illustrating an LDO circuit of an internal voltage generating circuit in accordance with a sixth embodiment of the present invention.

FIG. 8 is a circuit diagram illustrating an LDO circuit of an internal voltage generating circuit in accordance with a seventh embodiment of the present invention.

FIG. 9 is a circuit diagram illustrating an LDO circuit of an internal voltage generating circuit in accordance with an eighth embodiment of the present invention.

FIG. 10 is a circuit diagram illustrating an LDO circuit of an internal voltage generating circuit in accordance with a ninth embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

Since a Low-Drop-Out (LDO) circuit of an internal power generating circuit for generating an internal power voltage is simple and occupies a small area, it has been widely used. An internal power generating circuit in accordance with an embodiment of the present invention provides an improved LDO circuit and obtains a phase margin of the LDO circuit. Moreover, the internal power generating circuit including the LDO circuit in accordance with an embodiment of the present invention may be applied to a circuit having an amplifier, which enables MOS transistors.

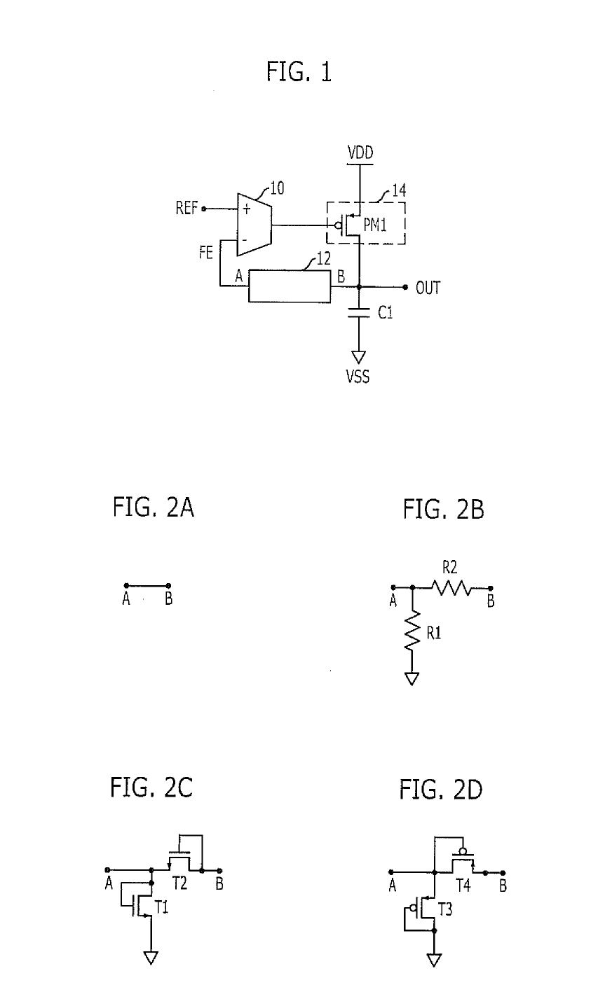

FIG. 1 is a block diagram illustrating an LDO circuit of an internal voltage generating circuit in accordance with a first embodiment of the present invention.

As shown in FIG. 1, the LDO circuit in accordance with a first embodiment of the present invention includes an amplifying unit 10, a feedback unit 12, an enable unit 14 and a first capacitor C1.

The amplifying unit 10 receives a reference signal REF and a feedback signal FE, and controls a PMOS transistor PM1. The amplifying unit 10 enables the PMOS transistor PM1 until the reference signal REF is identical to the feedback signal FE. The amplifying unit 10 receives the feedback signal through a negative input terminal, and controls the PMOS transistor PM1 such that the driving capacity of the PMOS transistor is reduced as the feedback signal FE is increased.

The feedback unit 12 receives the output signal OUT of the output node B and outputs the feedback signal to a feedback node A. The feedback unit 12 provides the feedback signal FE to the amplifying unit 10 if a voltage level of the output node B is increased.

The enable unit 14 includes a PMOS transistor PM1 which outputs an output signal OUT to an output node B. The first capacitor C1 is coupled between the output node B and a ground terminal VSS.

Meanwhile, the feedback unit 12 may be implemented in various manners as shown in FIGS. 2A to 2D.

That is, the feedback unit 12 may be configured with a coupling line without any element as shown in FIG. 2A. The feedback unit 12 may be configured with resistors R1 and R2 as shown in FIG. 2B. The feedback unit 12 may be configured with NMOS transistors T1 and T2 as shown in FIG. 2C. The feedback unit 12 may be configured with PMOS transistors T3 and T4 as shown in FIG. 2D.

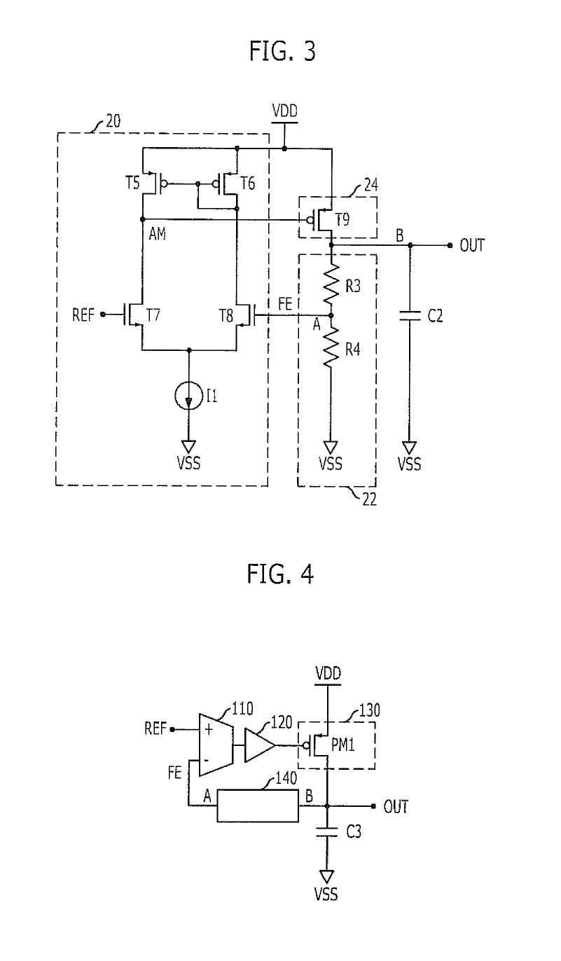

FIG. 3 is a circuit diagram illustrating an LDO circuit of an internal voltage generating circuit in accordance with a second embodiment of the present invention.

As shown in FIG. 3, the LDO circuit in accordance with a second embodiment of the present invention includes an amplifying unit 20, a feedback unit 22, an enable unit 24 and a second capacitor C2.

The amplifying unit 20 receives a reference signal REF and a feedback signal FE and outputs an amplified signal AM having a gain in proportion to the increase of the feedback signal.

The amplifying unit 20 includes MOS transistors T5 and T6, MOS transistors T7 and T8 and a first current source I1.

The MOS transistors T5 and T6 form a current mirror. The MOS transistors T7 and T8 receive the reference signal REF and the feedback signal FE through their gates, respectively. Nodes of the MOS transistors T7 and T8 are coupled to the MOS transistors T5 and T6, respectively. The first current source I1 is coupled between a ground voltage terminal VSS and the other nodes of the MOS transistors T7 and T8.

The enable unit 24 includes a MOS transistor T9 of which a gate is coupled to a drain of the transistor T5. The MOS transistor T9 activates an output node B in response to the amplified signal AM of the amplifying unit 20.

The feedback unit 22 includes resistors R3 and R4 which are coupled in series between the output node B and the ground voltage terminal VSS. The feedback signal FE is provided from a feedback node A of the R3 and R4.

The second capacitor C2 is coupled between the output node B and the ground terminal VSS.

FIG. 4 is a block diagram illustrating an LDO circuit of an internal voltage generating circuit in accordance with a third embodiment of the present invention.

As shown in FIG. 4, the LDO circuit in accordance with a second embodiment of the present invention includes an amplifying unit 110, a transfer unit 120, an enable unit 130, a feedback unit 140 and a third capacitor C3.

The amplifying unit 110 amplifies a difference between a reference signal REF and a feedback signal FE of the feedback unit 140. The amplifying unit 110 includes a differential amplifier.

The transfer unit 120 transfers an output of the amplifying unit 110 as an enable control signal of the enable unit 130 and has an output resistance value smaller than an output resistance value of the amplifying unit 110.

The transfer unit 120 has a low input capacitance and an output resistance value lower than a high output resistance value of the amplifying unit 110.

That is, the amplifying unit 110 having the high output resistance value is electrically coupled to an input node of the transfer unit 120 having the low input capacitance, and an output node of the transfer unit 120 having the low output resistance value is electrically coupled to a PMOS transistor PM11 of the enable unit 130 having a high gate capacitance.

The enable unit 130 includes the PMOS transistor PM11, which enables an output node B. The feedback unit 140 receives an output signal of the output node B and outputs the feedback signal FE.

Meanwhile, the feedback unit 12 may be implemented in various manners as shown in FIGS. 2A to 2D.

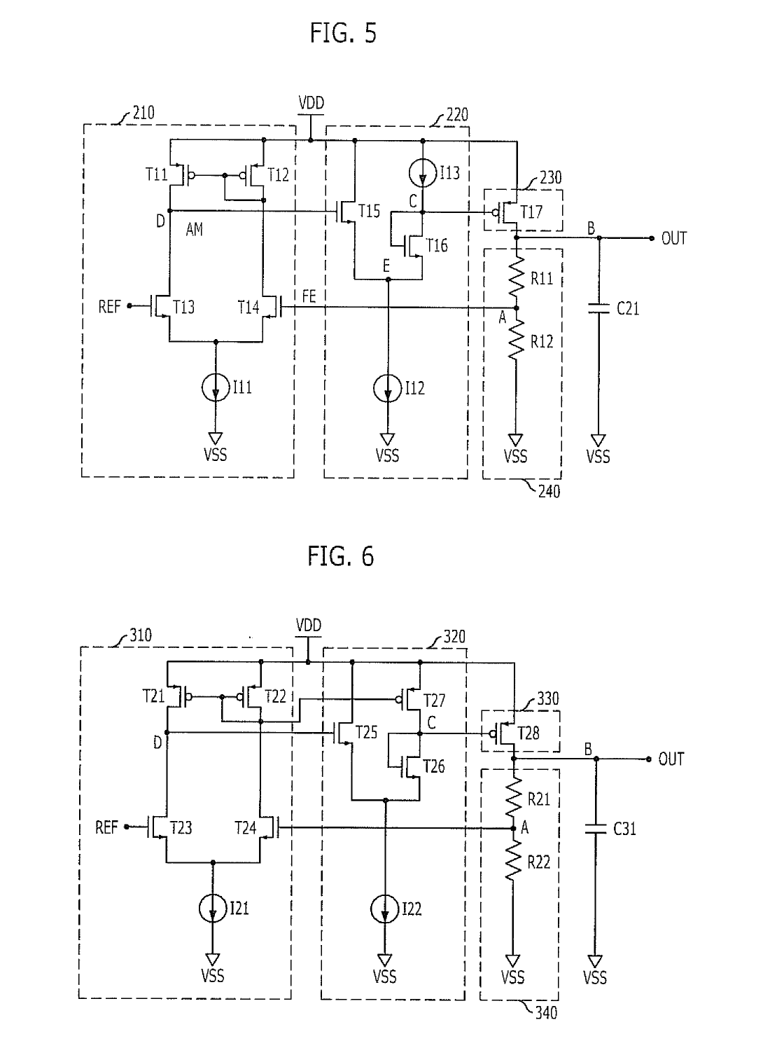

FIG. 5 is a circuit diagram illustrating an LDO circuit of an internal voltage generating circuit in accordance with a fourth embodiment of the present invention.

As shown in FIG. 5, the LDO circuit in accordance with a fourth embodiment of the present invention includes an amplifying unit 210, a transfer unit 220, an enable unit 230, a feedback unit 240 and a capacitor C21.

The amplifying unit 210 receives a reference signal REF and a feedback signal FE and outputs an amplified signal AM having a gain in proportion to the increase of the feedback signal.

The amplifying unit 210 includes MOS transistors T11 and T12, MOS transistors T13 and T14 and a current source I11.

The MOS transistors T11 and T12 form a current mirror. The MOS transistors T13 and T14 receive the reference signal REF and the feedback signal FE through their gates, respectively. Nodes of the MOS transistors T13 and 114 are coupled to the MOS transistors T11 and T12, respectively. The current source I11 is coupled between a ground voltage terminal VSS and the other nodes of the MOS transistors T13 and T14.

It is preferred that the amplifying unit 210 is designed to have a negative feedback loop having a large loop gain.

The transfer unit 220 includes at least one transfer MOS transistor T15, which receives the amplified signal AM through its gate so that an output resistance value at an output node D of the amplifying unit 210 is smaller than an output resistance value at an output node C of the transfer unit 220.

The transfer unit 220 includes a MOS transistor T15, a current source I13, an MOS transistor T16 and a current source I12.

One node of the MOS transistor T15 is coupled to a power supply voltage terminal VDD, and the other node of the MOS transistor T15 is coupled to a transfer node E of the transfer unit 220. It is preferred that the gate capacitance of the transfer MOS transistor T15 is designed to be small.

The current source I13 is coupled between the power supply voltage terminal VDD and the output node C of the transfer unit 220.

The MOS transistor T16 is coupled between the output node C of the transfer unit 220 and the transfer node E. The current source I12 is coupled between the transfer node E and the ground voltage terminal VSS.

The enable unit 230 includes a MOS transistor T17 of which a gate is coupled to the output node C of the transfer unit 220. The MOS transistor T17 activates an output node B.

The feedback unit 240 receives an output signal of the output node B and outputs the feedback signal FE. The feedback unit 240 includes resistors R11 and R12 which are coupled in series between the output node B and the ground voltage terminal VSS. The feedback signal FE is provided from a feedback node A of the resistors R3 and R4.

The fourth capacitor C21 is coupled between the output node B and the ground terminal VSS.

FIG. 6 is a circuit diagram illustrating an LDO circuit of an internal voltage generating circuit in accordance with a fifth embodiment of the present invention.

As shown in FIG. 6, the LDO circuit in accordance with a fifth embodiment of the present invention includes an amplifying unit 310, a transfer unit 320, an enable unit 330, a feedback unit 340 and a fifth capacitor C31.

The configuration of the LDO circuit is identical to the configuration of the LDO circuit except that the current source I13 shown in FIG. 5 is replaced by the MOS transistor T27 shown in FIG. 6.

Accordingly, a detailed description about the configuration of the LDO circuit will be omitted other than that of the MOS transistor T27 shown in FIG. 6.

A source of the MOS transistor T27 is coupled to a power supply voltage terminal VDD, and a drain of the MOS transistor T27 is coupled to the node C. A gate of the MOS transistor T27 is commonly coupled to gates of MOS transistors T21 and T22, which form a current mirror.

Because the gate of the MOS transistor T27 is coupled to the gates of the MOS transistors T21 and T22, which are performed as a current mirror, a current enable capacity of the transfer unit 320 is improved.

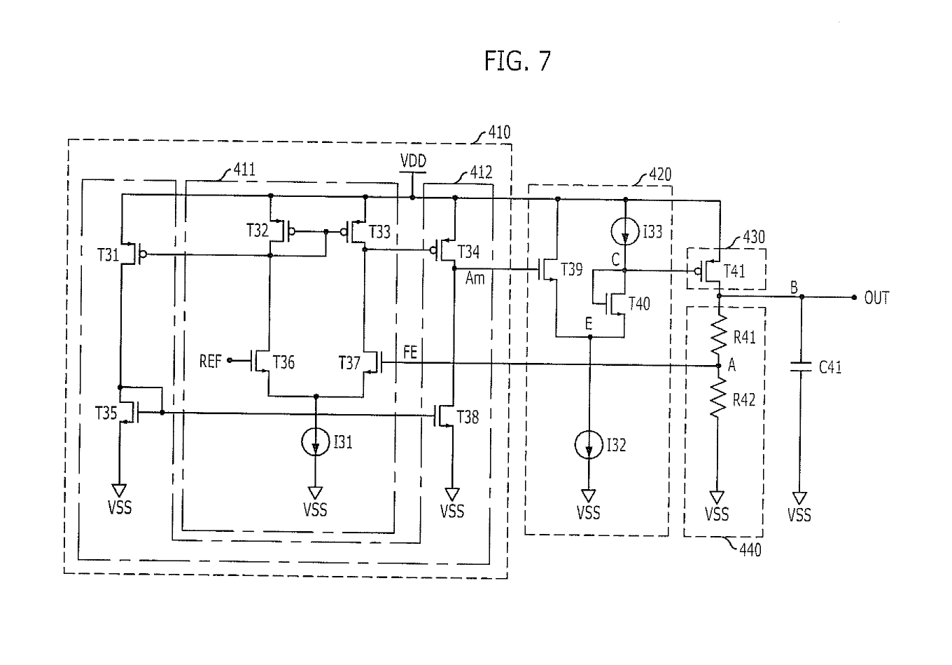

FIG. 7 is a circuit diagram illustrating an LDO circuit of an internal voltage generating circuit in accordance with a sixth embodiment of the present invention.

As shown in FIG. 7, the LDO circuit in accordance with a sixth embodiment of the present invention includes an amplifying unit 410, a transfer unit 420, an enable unit 430, a feedback unit 440 and a sixth capacitor C41.

The configuration of the LDO circuit shown in FIG. 7 is identical to the configuration of the LDO circuit in FIG. 5 except that the amplifying unit 210 is replaced by the amplifying unit 410 shown in FIG. 7.

Accordingly, a detailed description about the configuration of the LDO circuit is omitted other than that of the amplifying unit 410 shown in FIG. 7.

The amplifying unit 410 includes a first differential amplifier 411, which receives a reference signal REF and a feedback signal FE and amplifies a difference between the two signals, and a second differential amplifier 412, which amplifies an output of the first differential amplifier 411 and outputs an amplified signal AM.

The first differential amplifier 411 includes MOS transistors T32 and T33, MOS transistors T36 and T37 and a current source I31.

Sources of the MOS transistors T32 and T33 are commonly coupled to a power supply voltage terminal VDD. The MOS transistors T32 and T33 form a current mirror.

The T36 and T37 receive the reference signal REF and the feedback signal FE through their gates, respectively. Sources of the T36 and T37 are coupled to drains of the MOS transistors T32 and T33, respectively.

The current source I31 is coupled between a ground voltage terminal VSS and drains of the T36 and T37.

The second differential amplifier 412 includes MOS transistors T31 and T34, and MOS transistors T35 and T38.

The sources of the MOS transistors T31 and T34 are commonly coupled to the power supply voltage terminal VDD. Gates of the MOS transistors T31 and T34 are coupled to the drains of the MOS transistors T32 and T33, respectively.

Drains of the MOS transistors T35 and T38 are commonly coupled to the ground voltage terminal VSS and form a current mirror.

As shown in FIG. 7, the LDO circuit in accordance with a sixth embodiment of the present invention improves an entire operation speed of the LDO circuit by using two-step amplifiers.

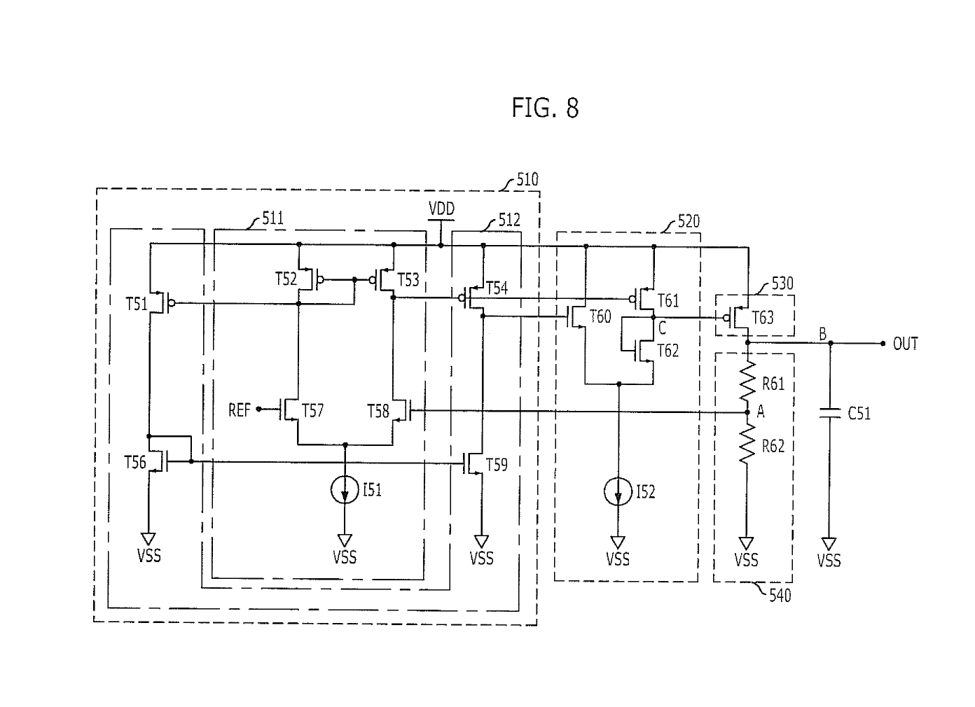

FIG. 8 is a circuit diagram illustrating an LDO circuit of an internal voltage generating circuit in accordance with a seventh embodiment of the present invention.

As shown in FIG. 8, the LDO circuit in accordance with a seventh embodiment of the present invention includes an amplifying unit 510, a transfer unit 520, an enable unit 530, a feedback unit 540 and a seventh capacitor C51.

The configuration of the LDO circuit is identical to the configuration of the LDO circuit except that the MOS transistor T61 shown in FIG. 8 replaces the current source I33 shown in FIG. 7.

Accordingly, detailed description about the configuration of the LDO circuit is omitted other than the MOS transistor T61 shown in FIG. 8.

A source of the MOS transistor T61 is coupled to the power v supply terminal VDD, and a drain of the MOS transistor T61 is coupled to the node C. A gate of the MOS transistor T61 is coupled to a gate of the MOS transistor T54.

If the gate of the MOS transistor T61 is coupled to input nodes of two-step amplifiers 511 and 512, the LDO circuit having the transfer unit 520 and two-step amplifiers 511 and 512 prevent a response characteristic from being deteriorated.

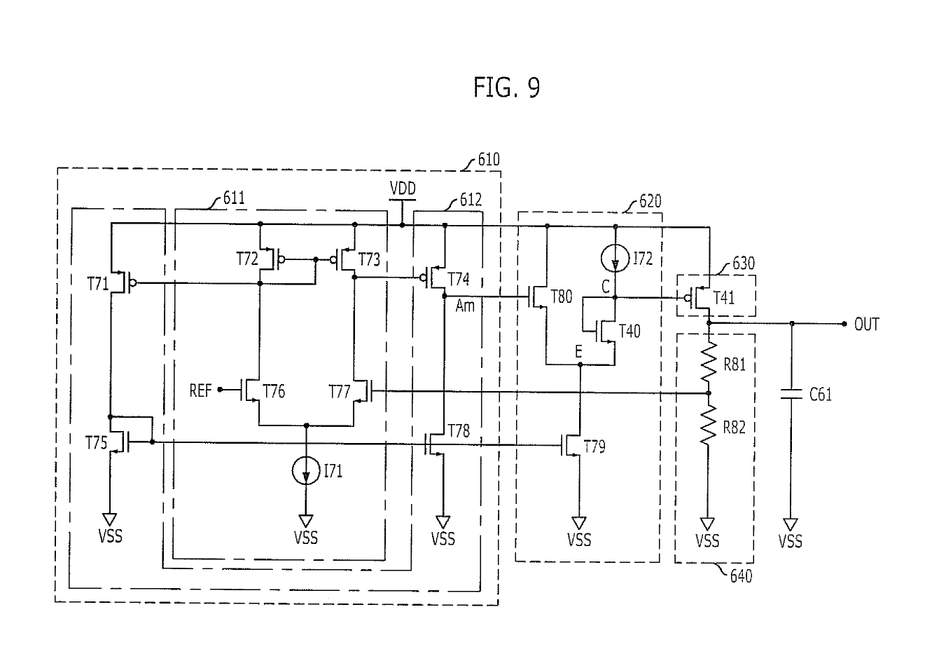

FIG. 9 is a circuit diagram illustrating an LDO circuit of an internal voltage generating circuit in accordance with an eighth embodiment of the present invention.

As shown in FIG. 9, the LDO circuit in accordance with an eighth embodiment of the present invention includes an amplifying unit 610, a transfer unit 620, an enable unit 630, a feedback unit 640 and an eighth capacitor C61.

The configuration of the LDO circuit is identical to the configuration of the LDO circuit except that the current source I32 shown in FIG. 7 is replaced by a MOS transistor T79 shown in FIG. 9.

Accordingly, a detailed description about the configuration of the LDO circuit is omitted other than that of the MOS transistor T79 shown in FIG. 9.

A drain of the MOS transistor T79 is coupled to a ground voltage terminal VSS, and a source of the MOS transistor T79 is coupled to the transfer node E. A gate of the MOS transistor T79 is coupled to gates of MOS transistor T75 and T78.

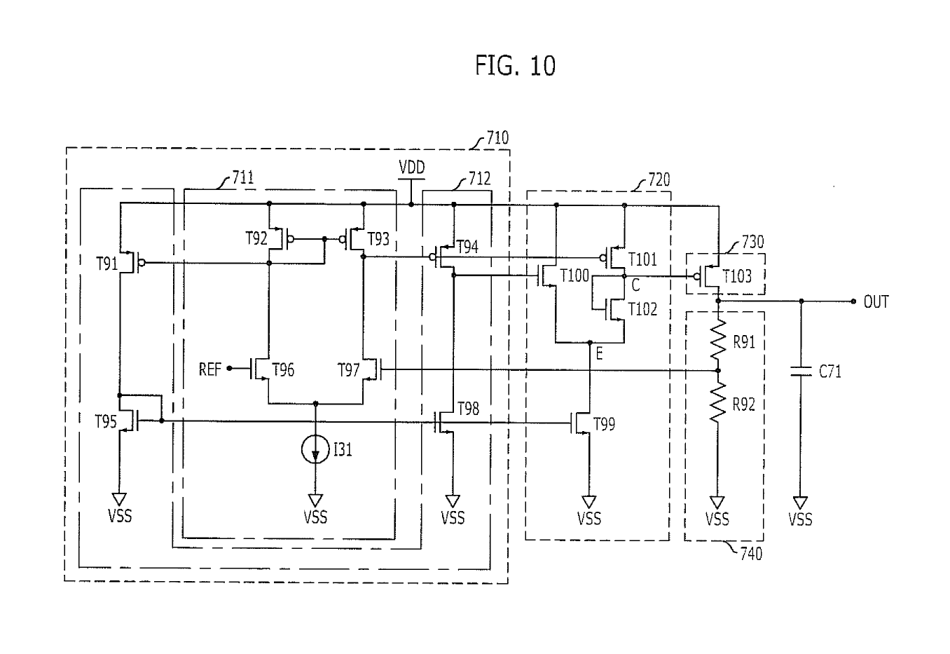

FIG. 10 is a circuit diagram illustrating an LDO circuit of an internal voltage generating circuit in accordance with a ninth embodiment of the present invention.

As shown in FIG. 10, the LDO circuit in accordance with a ninth embodiment of the present invention includes an amplifying unit 710, a transfer unit 720, an enable unit 730, a feedback unit 740 and a capacitor C71.

The configuration of the LDO circuit is identical to the configuration of the LDO circuit except that the current source I72 shown in FIG. 9 is replaced by a MOS transistor T101 shown in FIG. 10.

Accordingly, a detailed description about the configuration of the LDO circuit is omitted other than that of the MOS transistor T101 shown in FIG. 10.

A source of the MOS transistor T101 is coupled to the power supply voltage terminal VDD, and a drain of the MOS transistor T101 is coupled to the node C. A gate of the MOS transistor T101 is coupled to a gate of the MOS transistor T794.

The LDO circuit in accordance with embodiments of the present invention improves an operation speed and a phase margin by coupling a transfer unit between an amplifying unit and an enable unit. Here, the transfer unit operates as a buffer.

That is, the enable unit having a small gate capacitance instead of a large gate capacitance is coupled to the amplifying unit by additionally coupling a DC level compensation circuit after a transistor as a source follower coupled between the amplifying unit and the enable unit. Because the gate of the enable unit is coupled to a source node of the source follower, the gate of the enable unit has low impedance.

The enable unit prevents the phase margin from being decreased, and increases a size of MOS transistors of the enable unit irrespective of the stability. Moreover, a current for enabling the MOS transistors of the driving units may be reduced. An offset concern of the amplifying unit which is caused by the MOS transistors of the enable unit having a large size may be addressed.

The LDO circuit in accordance with embodiments of the present invention improves an operation performance.

While the present invention has been described with respect to the specific embodiments, it will be apparent to those skilled in the art that various changes and modifications may be made without departing from the spirit and scope of the invention as defined in the following claims.

What is claimed is:

1. A semiconductor device, comprising:
an enable unit configured to enable an output terminal;
a feedback unit configured to receive an output of the output terminal and output a feedback signal;
an amplifying unit configured to amplify a difference between a reference signal and the feedback signal; and
a transfer unit configured to transfer an amplified signal of the amplifying unit as an enable control signal of the enable unit, and to have an output resistance value smaller than an output resistance value of the amplifying unit.

2. The semiconductor device of claim 1, wherein the feedback unit comprises:
a first resistor coupled between the output terminal and an input node of the amplifying unit; and
a second resistor coupled between the input node of the amplifying unit and a ground voltage terminal.

3. The semiconductor device of claim 1, wherein the feedback unit comprises:
a first MOS transistor coupled between the output terminal and the input node of the amplifying unit; and
a second MOS transistor coupled between the input terminal of the amplifying unit and a ground voltage terminal.

4. The semiconductor device of claim 1, wherein the amplifying unit includes a differential amplifier.

5. A semiconductor device, comprising:
an enable unit configured to receive an enable signal and to enable an output terminal;
a feedback unit configured to receive an output signal of the output terminal and to output a feedback signal;
an amplifying unit configured to receive a reference signal and the feedback signal and to output an amplified signal having a gain in proportion to an increase of the feedback signal; and
a transfer unit configured to receive the amplified signal and to output the enable signal to the enable unit,
wherein the transfer unit has an output resistance value smaller than an output resistance value of the amplifying unit.

6. The semiconductor device of claim 5, wherein the transfer unit comprises:
at least one transfer MOS transistor configured to receive the amplified signal through a gate and to have a node coupled to a power supply voltage terminal and the other node coupled to a transfer node;
a first current source coupled between the power supply voltage terminal and an output node of the transfer unit;
a first MOS transistor coupled between the output node of the transfer unit and the transfer node; and
a second current source coupled between the transfer node and a ground voltage terminal.

7. The semiconductor device of claim 5, wherein the enable unit includes a MOS transistor having a gate coupled to the output node and enabling the output terminal.

8. The semiconductor device of claim 7, wherein the feedback unit includes first and second resistors which are coupled in series between the output terminal and the ground voltage terminal, and the feedback signal is provided from a common node of the first and second resistors.

9. The semiconductor device of claim 6, wherein the amplifying unit comprises:
second and third MOS transistors configured to form a current mirror;
fourth and fifth MOS transistors configured to receive the reference signal and the feedback signal at respective gates and each having a node coupled to a respective one of the second and third MOS transistors; and
a third current source coupled between the ground voltage terminal and the other nodes of the fourth and fifth MOS transistors.

10. The semiconductor device of claim 9, wherein the first current source includes a sixth MOS transistor having a node coupled to the power supply voltage terminal and another node coupled to the output node, and a gate coupled to a gate of the second and third MOS transistors.

11. The semiconductor device of claim 5, wherein the amplifying unit comprises:
a first differential amplifier configured to receive and amplify a difference between the reference signal and the feedback signal; and
a second differential amplifier configured to amplify an output signal of the first differential amplifier and to output the amplified signal.

12. The semiconductor device of claim 11, wherein the first differential amplifier comprises:
seventh and eighth MOS transistors configured to form a current mirror, each having a node commonly coupled to the power supply voltage terminal;
ninth and tenth MOS transistors configured to receive the reference signal and the feedback signal through their respective gates and each having a node coupled to a respective one of the seventh and eighth MOS transistors; and
a fourth current source coupled between the ground voltage terminal and the other nodes of the ninth and tenth MOS transistors.

13. The semiconductor device of claim 12, wherein the second differential amplifier comprises:
eleventh and twelfth MOS transistors, each having a node coupled to the power supply voltage terminal and a gate coupled to the other nodes of the seventh and eighth MOS transistors; and
thirteenth and fourteenth MOS transistors configured to form the current mirror,
wherein the eleventh and twelfth MOS transistors are coupled to nodes of the thirteenth and fourteenth MOS transistors, and the ground voltage terminal is coupled to the other nodes of the thirteen and fourteenth MOS transistors.

14. The semiconductor device of claim 13, wherein the transfer unit comprises:
at least one transfer MOS transistor configured to receive the amplified signal through a gate and to have a node coupled to the power supply voltage terminal and the other node coupled to a transfer node;
a fifth current source coupled between the power supply voltage terminal and an output node of the transfer unit;
a fifteenth MOS transistor coupled between the output node of the transfer unit and the transfer node; and
a sixth current source coupled between the transfer node and the ground voltage terminal.

15. The semiconductor device of claim 14, wherein the fifth current source comprises a sixteenth MOS transistor having a node coupled to the power supply voltage terminal, the other node coupled to the output node, and a gate coupled to a gate of the ninth MOS transistor.

16. The semiconductor device of claim 14, wherein the sixth current source comprises a seventeenth MOS transistor having a node coupled to the power supply voltage terminal, the other node coupled to the transfer node, and a gate coupled to a gate of the thirteenth and fourteenth MOS transistors.

17. The semiconductor device of claim 14, wherein the fifth current source comprises a sixteenth MOS transistor having a node coupled to the power supply voltage terminal, the other node coupled to the output node, and a gate coupled to a gate of the ninth MOS transistor, and wherein the sixth current source comprises a seventeenth MOS transistor having a node coupled to the power supply voltage terminal, the other node coupled to the transfer node, and a gate coupled to a gate of the thirteenth and fourteenth MOS transistors.

18. An internal power generating circuit, comprising:
an enable unit configured to receive an enable signal and to enable an output terminal;
a feedback unit configured to receive an output signal of the output terminal and to output a feedback signal;
an amplifying unit configured to receive a reference signal and the feedback signal and to output an amplified signal having a gain in proportion to an increase of the feedback signal; and
a transfer unit configured to receive the amplified signal and to output the enable signal to the enable unit,
wherein the transfer unit has an output resistance value smaller than an output resistance value of the amplifying unit.

19. The internal power generating circuit of claim 18, wherein the amplifying unit comprises:
a first differential amplifier configured to receive and amplify a difference between the reference signal and the feedback signal; and
a second differential amplifier configured to amplify an output signal of the first differential amplifier and to output the amplified signal.

20. The internal power generating circuit of claim 18, wherein the transfer unit comprises:
at least one transfer MOS transistor configured to receive the amplified signal through a gate and to have a node coupled to a power supply voltage terminal and the other node coupled to a transfer node;
a first current source coupled between the power supply voltage terminal and an output node of the transfer unit;
a first MOS transistor coupled between the output node of the transfer unit and the transfer node; and
a second current source coupled between the transfer node and a ground voltage terminal.
